(19) United States
(12) Patent Application Publication
(10) Pub. No.: US 2012/0312421 A1
(43) Pub. Date: Dec. 13, 2012

(54) HYDRAULIC BUNCHING FINGER

(75) Inventor: Michael G. Trom, Blooming Prairie, MN (US)

(73) Assignee: Caterpillar Forest Products Inc., Peoria, IL (US)

(21) Appl. No.: 13/154,815

(22) Filed: Jun. 7, 2011

(51) Int. Cl. A01G 23/081; A01G 23/099

(52) U.S. Cl. 144/4.1; 144/250.26; 144/34.1

(57) ABSTRACT

A hydraulic biasing assembly is provided. The hydraulic bunching assembly may include a hydraulic circuit and a hydraulic biasing member configured to provide bias to a bunching finger of a tree felling head. The hydraulic biasing assembly may also include a valve configured to alternately allow hydraulic fluid to transfer from the hydraulic circuit to the hydraulic biasing member and to allow hydraulic fluid to transfer from the hydraulic biasing member to a collector.

### TECHNICAL FIELD

Embodiments of the present disclosure pertain to tree felling heads, and more particularly, to hydraulic biasing members of bunching fingers of tree felling heads.

### BACKGROUND

A modern tree felling head generally includes a frame with a large accumulating area, a device for severing trees, and two sets of arms for gathering and holding trees. A gathering arm is a rigid body that rotates about a point in the frame and is used for pulling trees into the accumulation area after they are severed. A bunching finger is a hinged member that rotates about a different point on the frame and is used to hold severed trees in the accumulation area while another is being severed.

In operation, after a first tree has been severed and moved into the accumulation area by the gathering arm the bunching finger is then actuated to come in contact with this tree and secure it in the accumulation area. The gathering arm can now be opened so that another tree can be severed. As the second tree is severed, it is pulled into the accumulation area and pulled tight against the bunching finger, which remains positioned in the accumulation area. The bunching finger is then retracted (e.g., reset). To accomplish this reset, the bunching finger has to fold in a manner to clear the first two trees that were severed and are being held in the accumulation area by the gathering arm. Once the bunching finger has been opened a sufficient distance to clear the first and second trees severed (still being held by the gathering arm), the bunching finger reverses and engages both severed trees. This cycle continues until the accumulation area is full.

An example of a tree felling head is disclosed in U.S. Pat. No. 7,832,427 (the '427 patent) on Nov. 16, 2010. The '427 patent discloses a tree felling head which describes a bunching finger including a spring biasing member.

### SUMMARY

According to an aspect of the disclosures herein, a hydraulic biasing assembly includes: a hydraulic biasing member configured to bias a bunching finger of a tree felling head; and a hydraulic circuit configured to provide hydraulic fluid to the hydraulic biasing member, the hydraulic circuit including a hydraulic pump. The hydraulic circuit may further include a hydraulic motor configured to drive a cutting device (e.g., a cutting blade) of the tree felling head.

The hydraulic biasing member may include a cushion configured to reduce the movement rate of the hydraulic biasing member. The hydraulic biasing assembly may further include a valve fluidly coupled between the hydraulic circuit and the hydraulic biasing member, wherein the valve is configured to alternately allow hydraulic fluid to transfer from the hydraulic circuit to the hydraulic biasing member and to allow the hydraulic fluid to transfer from the hydraulic biasing member to a collector. The valve may be further configured to allow hydraulic fluid from the hydraulic biasing member to drain to the collector when the hydraulic motor is off.

The hydraulic biasing member may include a rod end and a base end, and wherein the rod end is configured to connect to an inner arm of the bunching finger of the tree felling head, and the base end is configured to connect to a frame of the tree felling head.

According to an aspect of the disclosures herein, a bunching finger includes: an inner arm; an outer arm pivotally coupled to the inner arm; a hydraulic biasing member directly coupled to the inner arm and adapted to pivot the inner arm, the hydraulic biasing member hydraulically coupled to a hydraulic circuit; and an actuator coupled to the outer arm, the actuator configured to pivot the inner arm through restraint of the hydraulic biasing member and to cooperatively retract the bunching finger with the hydraulic biasing member.

The hydraulic circuit may include a hydraulic pump configured to drive a hydraulic motor for driving a cutting device and to provide hydraulic fluid to the hydraulic biasing member. The hydraulic biasing member may include a cushion configured to reduce the movement rate of the hydraulic biasing member.

The bunching finger may further comprise a valve fluidly coupled between the hydraulic circuit and the hydraulic biasing member, the valve configured to alternately allow hydraulic fluid to transfer from the hydraulic circuit to the hydraulic biasing member and to allow the hydraulic fluid to transfer from the hydraulic biasing member to a collector. The valve may be further configured to allow hydraulic fluid from the hydraulic biasing member to drain to the collector when the hydraulic motor is off.

The hydraulic biasing member may include a rod end and a base end, and wherein the rod end is connected to the inner arm and the base end is connected to a frame of the tree felling head.

The inner arm may be configured to be pivotally coupled to a felling head frame having an accumulation area and is further configured to pivot toward and away from the accumulation area between a retracted position and a stop position. The outer arm may be configured to pivotally sweep the accumulation area from the stop position of the inner arm. And the hydraulic biasing member is configured to urge movement of the bunching finger toward the accumulation area.

According to an aspect of the disclosures herein, a tree felling head includes: a frame having an accumulation area; a gathering arm mounted to the frame; a cutting device; a hydraulic circuit including a hydraulic pump and a hydraulic motor, the hydraulic pump configured to drive the hydraulic motor, and the hydraulic motor configured to drive the cutting device; a bunching finger including: an inner arm; an outer arm pivotally coupled to the inner arm; a hydraulic biasing member directly coupled to the inner arm and adapted to pivot the inner arm; and an actuator coupled to the outer arm, the actuator configured to pivot the inner arm through restraint of the hydraulic biasing member and to cooperatively retract the bunching finger with the hydraulic biasing member.

The hydraulic biasing member includes a cushion configured to reduce the movement rate of the hydraulic biasing member.

The bunching finger may further include a stop positioned to arrest pivotal movement of the inner arm.

The tree felling head may further include a valve connected between the hydraulic circuit and the hydraulic biasing member, the valve configured to alternately allow hydraulic fluid to transfer from the hydraulic motor to the hydraulic biasing member or to allow the hydraulic fluid to transfer from the hydraulic biasing member to a collector.

The valve may be further configured to allow hydraulic fluid from the hydraulic biasing member to drain to the collector when the hydraulic motor is off.

The hydraulic biasing member may include a rod end and a base end, and wherein the rod end is coupled to the inner arm and the base end is coupled to the frame. The inner arm is pivotally coupled to the frame and configured to pivot toward and away from the accumulation area between a retracted position and a stop position. The outer arm is configured to pivotally sweep the accumulation area from the stop position of the inner arm. And, the hydraulic biasing member is configured to urge movement of the bunching finger toward the accumulation area.

### BRIEF DESCRIPTION OF THE DRAWINGS

FIGS. 1-2 are perspective views of a tree harvesting head according to an embodiment herein;

FIG. 3 is a perspective view of a bunching finger of a tree harvesting head as illustrated in FIG. 1;

FIGS. 4-5 are perspective views of a bunching finger and hydraulic motor of a harvesting head as illustrated in FIG. 1.

FIG. 6 is a block diagram of a hydraulic biasing assembly of a harvesting head as illustrated in FIG. 1.

FIG. 7 is a block diagram of a hydraulic bunching assembly of a harvesting head as illustrated in FIG. 1

### DETAILED DESCRIPTION

Exemplary embodiments of the present invention are presented herein with reference to the accompanying drawings. Herein, like numerals designate like parts throughout.

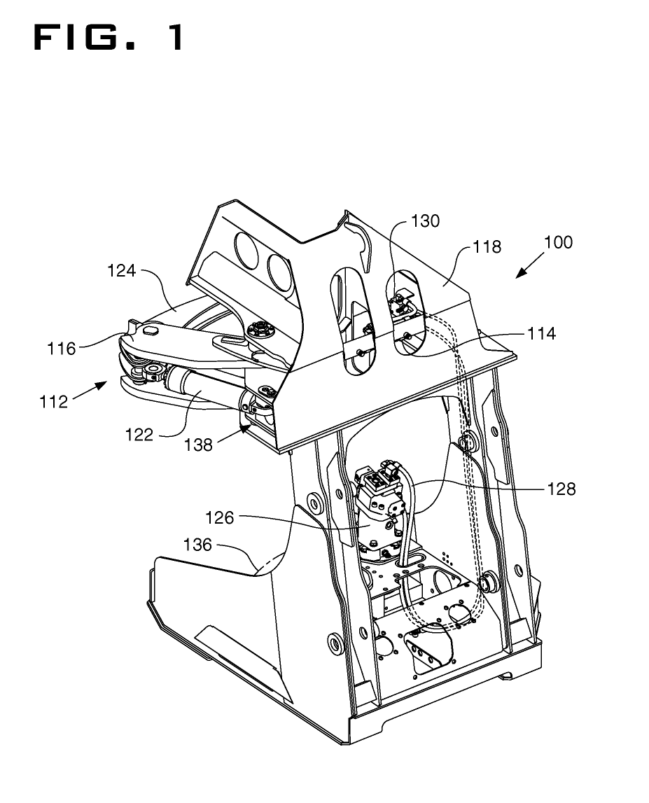

FIGS. 1-2 are perspective views of a tree harvesting head according to an embodiment herein.

Referring to FIGS. 1-2, according to embodiments of the present invention, a tree felling head 100 includes a gathering arm 110, a bunching finger 112, a frame 118, a cutting device (e.g., a cutting blade) 136, a hydraulic circuit 126, and an accumulation area 120 for storing felled trees. The hydraulic circuit 126 includes a hydraulic pump and a hydraulic motor for driving the cutting blade. The hydraulic pump is configured to drive the hydraulic motor and may also be configured to provide hydraulic fluid to drive a hydraulic biasing member 114. The tree felling head may also include a stop (e.g., inner arm stop) 138 to regulate or restrict the movement of the bunching finger 112 (e.g., during a reset of the bunching finger).

The bunching finger 112 may include an inner arm 116, an outer arm 124, an actuator (e.g., a bunching cylinder) 122, and a hydraulic biasing member (e.g., a hydraulic cylinder) 114. The hydraulic biasing member 114 may be attached between the inner arm 116 and the frame 118. The actuator (e.g., bunching cylinder) 122 may be connected between the frame 118 and the outer arm 124 of the bunching finger 112. The hydraulic circuit 126 may be configured to drive the hydraulic biasing member (e.g., in a generally constant motion).

According to embodiments of the preset invention, the inner arm 116 is configured to rotate about a point located on the frame, and the outer arm 124 is configured to rotate about the distal end of the inner arm 116. This rotation of the outer arm provides the folding motion to open and close entry to the accumulation area 120, and thus hold the severed trees during the bunching process.

The hydraulic biasing member 114 may be configured to control when the bunching finger 112 is energized, the maximum amount of biasing force applied by the bunching finger 112, and the amount of force used to return or reset the bunching finger 112. Additionally, the hydraulic biasing member 114 may be configured to reduce the number of and/or force of impacts caused by the resetting bunching finger 112 on the tree felling head 100.

According to embodiments herein, a hydraulic biasing member 114 may be configured to apply a force (e.g., a generally constant force) on the inner arm 116 urging it to travel to the extent of it's rotation towards the accumulation area 120. In other words, the hydraulic biasing member 114 may configured to bias a bunching finger 112 of the felling head 100 towards the closed position. Furthermore, according to embodiments herein, a hydraulic circuit 126 fluidly coupled to the hydraulic biasing member 114, may be configured to provide hydraulic fluid to drive the hydraulic biasing member 114. The hydraulic circuit may include a hydraulic motor for driving a cutting device and a hydraulic pump configured to drive the hydraulic motor and to provide hydraulic fluid to drive the hydraulic biasing member 114.

As the bunching finger cylinder 112 is extended, the hydraulic biasing member 114 helps force the inner arm 116 to rotate towards the accumulation area 120. Appropriate linkage may be used to couple the hydraulic biasing member 114 to the inner arm 116 in order to provide an appropriate force and urge movement of the inner arm 116 towards the accumulation area 120. Because the force of the hydraulic biasing member 114 keeps the inner arm 116 rotating in pace with, for example, an actuator 122 (e.g., an elongating hydraulic cylinder 122, and also referred to as a bunching cylinder 122) attached to the outer arm 124 and frame 118, there is generally little to no relative rotation between the inner arm 116 and outer arm 124 of the bunching finger 112. This general motion continues until the inner arm 116 has reached the extent of its rotation, e.g. a stop 138 is engaged. This stop 138 may be provided at various locations and take many different forms.

For instance, in various embodiments, when the bunching finger 112 is retracted to clear the previously cut tree, the outer arm 124 may push against the previously cut tree, which may tend to create a resultant force on the inner arm 116 of the bunching finger 112. This resultant force may be generally greater than and opposite to the force imposed by the hydraulic biasing member 114. As a result, the inner arm 116 may rotate away from the accumulation area 120 and the angle between the inner arm 116 and outer arm 124 decreases.

This general motion may continue until the outer arm 124 has cleared the previously cut tree. Once the outer arm 124 has cleared the previously cut tree, the resultant force of the actuator 122 acting on the inner arm 116 may be eliminated and the hydraulic biasing member 114 may then urge the inner arm to rotate back towards the extent of its rotation towards the accumulation area 120. The direction of the bunching cylinder 122 can then be reversed, the accumulation area 120 may be properly swept, and the trees may be properly retained.

In various embodiments, a stop 138 may be of a variety of configurations and may act on the inner arm 116, the hydraulic biasing member 114, or other component in order to cease pivotal movement of the inner arm 116. The outer arm 124 then begins to rotate about the inner arm 116 sweeping the accumulation area 120 as intended.

Additionally, according to embodiments herein, the hydraulic biasing member 114 may also include a cushion to decrease the speed and force of the bunching finger 112 during a reset. Reducing the speed of the bunching finger 112 reset thereby reduces force of the impact against the stop 138.

Hydraulic hose 128 may be used to connect the hydraulic motor 126 to the hydraulic biasing member 114. According to embodiments herein, the hydraulic circuit 126, including a hydraulic motor (e.g., cutting motor) and a hydraulic pump, may be configured to provide a pressure (e.g., a generally constant pressure) to the hydraulic biasing member 114 to provide a reset speed (e.g., a generally constant reset speed) of the bunching finger 112. Additionally, if the hydraulic biasing member 114 includes a cushion, then the rate of reset may be reduced at an appropriate position or positions to reduce the force of the reset of the bunching finger 112 prior to impacting the stop 138.

Additionally, when the hydraulic biasing member 114 is configured to be driven by the hydraulic circuit 126, the hydraulic biasing member 114 may be configured to drain the stored hydraulic fluid when the hydraulic circuit is turned off (e.g., such as when service is perform on the tree felling head 100 and the cutting motor and hydraulic pump are turned off.) Thus, the hydraulic biasing member may be configured to drain any stored pressure or energy in the hydraulic cylinder 114.

According to another embodiment described herein, instead of coupling the hydraulic biasing member 114 to the hydraulic circuit 126, the hydraulic biasing member 114 may be coupled to an independent hydraulic system or may be coupled to a hydraulic system used to control the bunching cylinder 122.

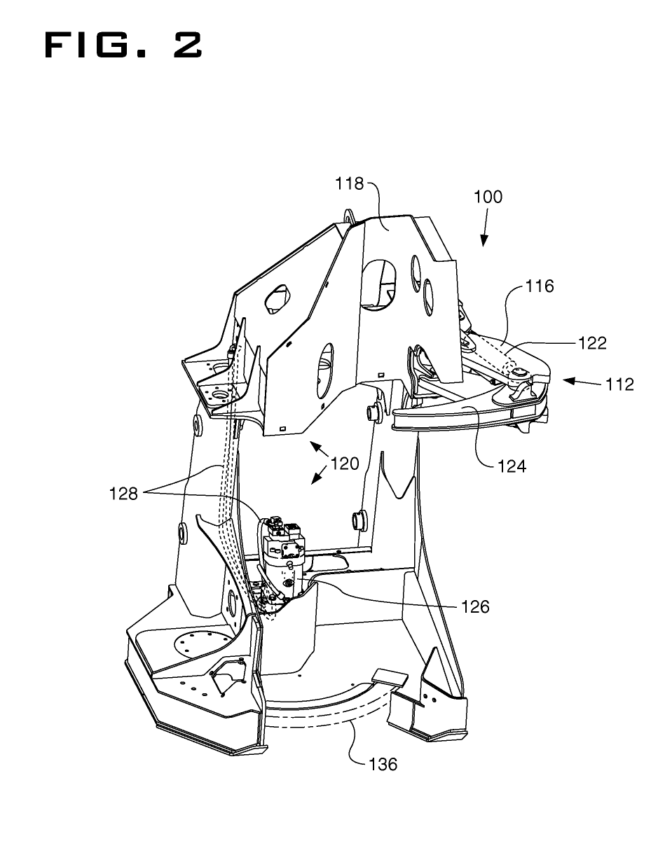

FIG. 3 is a perspective view of a bunching finger of a tree harvesting head as illustrated in FIG. 1. According to embodiments herein, the bunching finger 112 includes a hydraulic biasing member 114, an outer arm 124, an inner arm 116, an actuator (also referred to as a bunching cylinder) 122. The hydraulic biasing member may include hydraulic connectors 132 for allowing the flow of hydraulic fluid into and out of the hydraulic cylinder 114.

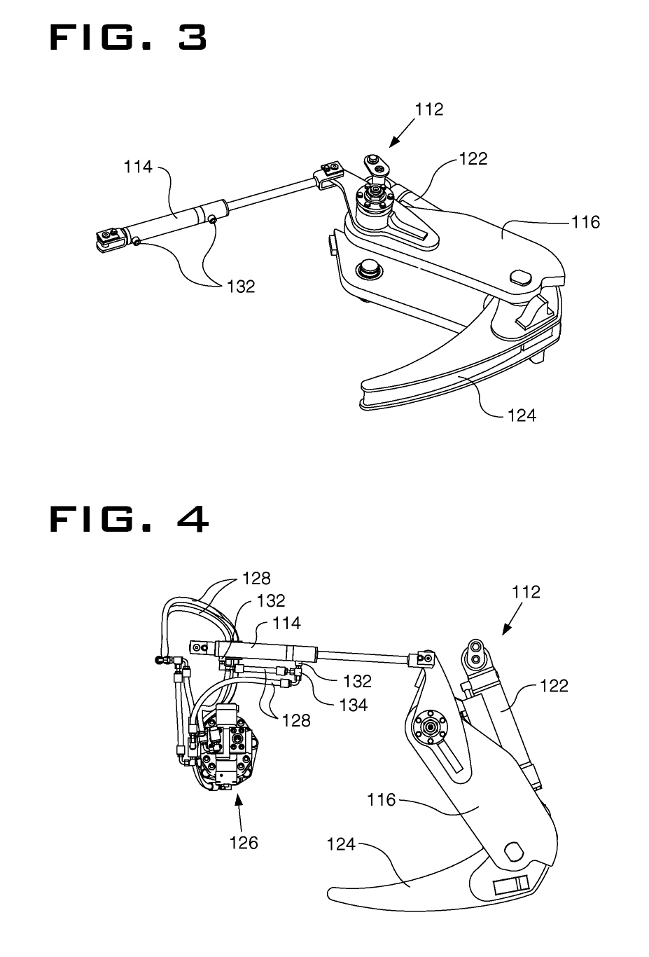

FIGS. 4-5 are perspective views of a bunching finger and hydraulic circuit of a harvesting head as illustrated in FIG. 1. According to embodiments herein, the hydraulic circuit 126 may be coupled to the hydraulic bunching cylinder 114 by hydraulic hoses 128. A valve (e.g., a reducing/relieving valve) 130 may also be coupled between the hydraulic circuit 126 and the hydraulic bunching cylinder 114, and may be configured to allow for the flow or drainage of hydraulic fluid.

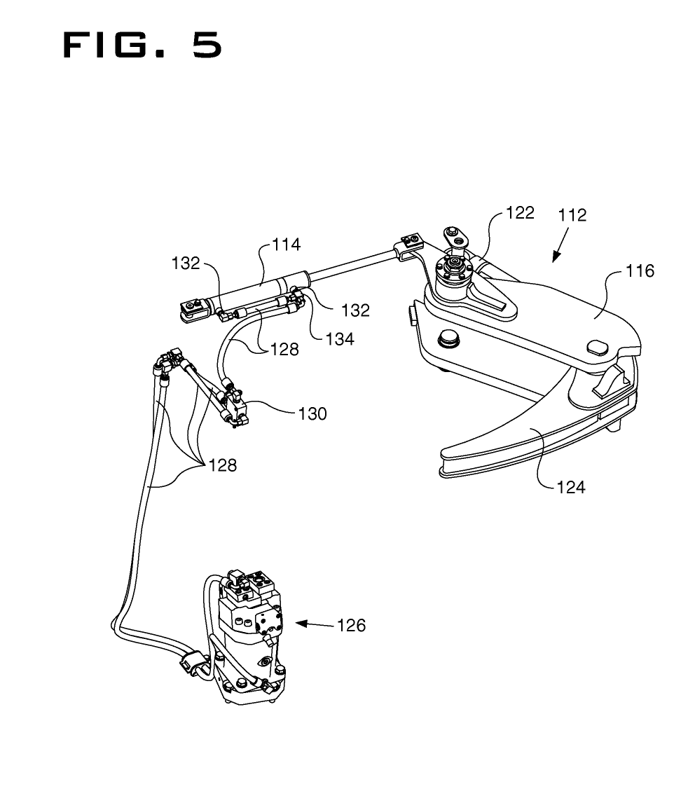

FIG. 6 is a block diagram of a hydraulic biasing assembly of a harvesting head as illustrated in FIG. 1. According to embodiments herein, a hydraulic biasing assembly 200 may include hydraulic bunching cylinder 114, a reducing/relieving valve 130, a collector (e.g., case drain) 140 for collecting hydraulic fluid, and a hydraulic circuit 126. The hydraulic circuit 126 may include a hydraulic pump and motor. The rod end 114A of the hydraulic biasing member 114 may be connected to the inner arm 116 of the bunching finger 112, and the base end 114B of the hydraulic biasing member 114 may be connected to the frame 118 of the felling head 100.

The valve 130 may be configured to direct the hydraulic fluid to the hydraulic bunching cylinder 114 or to the case drain 140, according to the desired operation of the bunching finger 112.

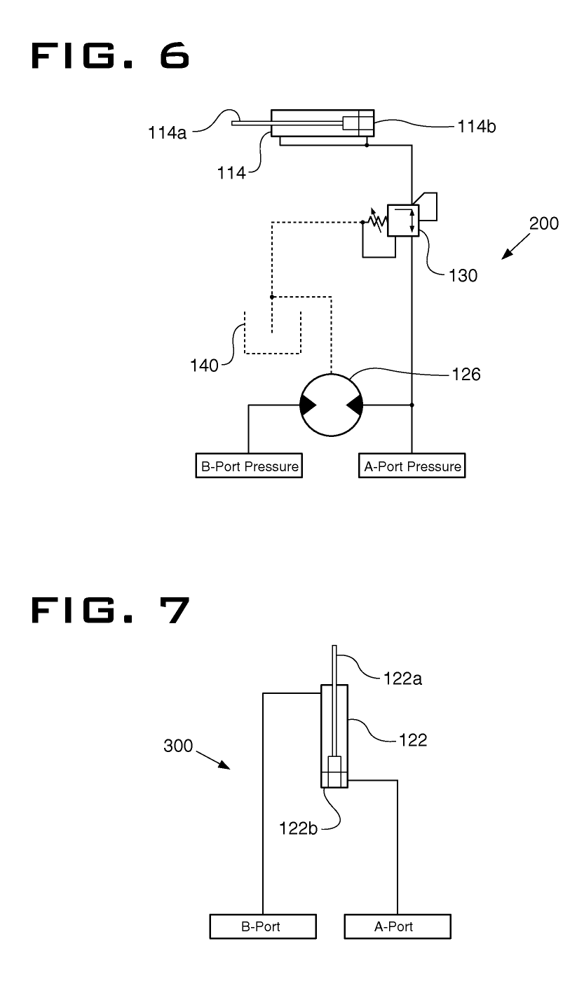

FIG. 7 is a block diagram of a hydraulic bunching assembly of a harvesting head as illustrated in FIG. 1. According to FIG. 7, a hydraulic bunching assembly 300 includes a bunching cylinder 122, and an a-port and b-port of a hydraulic pump. The rod end 122A of the bunching cylinder 122 may be connected to the outer finger 124 of the bunching finger 112, and the base end 122B of the bunching cylinder 122 may be connected to the frame 118 of the felling head 100.

The hydraulic bunching assembly 300 may be a separate system from the hydraulic biasing assembly 200. Separate hydraulic systems increase the independence of the two systems, and prevent the operation of the hydraulic biasing cylinder 114 or of the bunching cylinder 122 from interfering with the performance of the other. Additionally, controlling the hydraulic biasing cylinder 114 through use of the cutting circuit 126 may provide for more stable control of the hydraulic biasing cylinder 114, by allowing a generally constant flow of hydraulic fluid to the biasing cylinder.

### INDUSTRIAL APPLICABILITY

The disclosed hydraulic biasing member may be implemented in a bunching finger of a tree-felling head. A hydraulic biasing member provides for enhanced control over the bunching finger. Furthermore, embodiments disclosed herein allow for the application of generally constant pressure by the hydraulic biasing member and provide a hydraulic cushion in order to lessen or remove the impact generated during the reset of the bunching finger.

Although certain embodiments have been illustrated and described herein for purposes of description, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is intended that embodiments in accordance with the present invention be limited only by the claims and the equivalents thereof.

What is claimed is:

1. A hydraulic biasing assembly comprising:
a hydraulic biasing member configured to bias a bunching finger of a tree felling head; and
a hydraulic circuit configured to provide hydraulic fluid to the hydraulic biasing member, the hydraulic circuit comprising a hydraulic pump.

2. The hydraulic biasing assembly of claim 1 wherein the hydraulic circuit further comprises a hydraulic motor configured to drive a cutting blade of the tree felling head.

3. The hydraulic biasing assembly of claim 1 wherein the hydraulic biasing member comprises a cushion configured to reduce the movement rate of the hydraulic biasing member.

4. The hydraulic biasing assembly of claim 1 further comprising a valve fluidly coupled between the hydraulic circuit and the hydraulic biasing member, the valve configured to alternately allow hydraulic fluid to transfer from the hydraulic circuit to the hydraulic biasing member and to allow the hydraulic fluid to transfer from the hydraulic biasing member to a collector.

5. The hydraulic biasing assembly of claim 4 wherein the valve is further configured to allow hydraulic fluid from the hydraulic biasing member to drain to the collector when the hydraulic motor is off.

6. The hydraulic biasing assembly of claim 5 wherein the hydraulic biasing member comprises a rod end and a base end, and wherein the rod end is configured to connect to an inner arm of the bunching finger of the tree felling head, and the base end is configured to connect to a frame of the tree felling head.

7. A bunching finger comprising:
an inner arm;
an outer arm pivotally coupled to the inner arm;
a hydraulic biasing member directly coupled to the inner arm and adapted to pivot the inner arm, the hydraulic biasing member hydraulically coupled to a hydraulic circuit; and
an actuator coupled to the outer arm, the actuator configured to pivot the inner arm through restraint of the hydraulic biasing member and to cooperatively retract the bunching finger with the hydraulic biasing member.

8. The bunching finger of claim 7 wherein the hydraulic circuit comprises a hydraulic pump configured to drive a hydraulic motor for driving a cutting device and to provide hydraulic fluid to the hydraulic biasing member.

9. The hydraulic biasing assembly of claim 7 wherein the hydraulic biasing member comprises a cushion configured to reduce the movement rate of the hydraulic biasing member.

10. The bunching finger of claim 7 further comprising a valve fluidly coupled between the hydraulic circuit and the hydraulic biasing member, the valve configured to alternately allow hydraulic fluid to transfer from the hydraulic circuit to the hydraulic biasing member and to allow the hydraulic fluid to transfer from the hydraulic biasing member to a collector.

11. The bunching finger of claim 10 wherein the valve is further configured to allow hydraulic fluid from the hydraulic biasing member to drain to the collector when the hydraulic motor is off.

12. The bunching finger of claim 11 wherein the hydraulic biasing member comprises a rod end and a base end, and wherein the rod end is connected to the inner arm and the base end is connected to a frame of the tree felling head.

13. The bunching finger of claim 12, wherein the inner arm is configured to be pivotally coupled to a felling head frame having an accumulation area and is further configured to pivot toward and away from the accumulation area between a retracted position and a stop position, wherein the outer arm is configured to pivotally sweep the accumulation area from the stop position of the inner arm, and wherein the hydraulic biasing member is configured to urge movement of the bunching finger toward the accumulation area.

14. A tree felling head comprising:
a frame having an accumulation area;
a gathering arm mounted to the frame;
a cutting device;
a hydraulic circuit comprising a hydraulic pump and a hydraulic motor, the hydraulic pump configured to drive the hydraulic motor, and the hydraulic motor configured to drive the cutting device;
a bunching finger comprising:
an inner arm;
an outer arm pivotally coupled to the inner arm;
a hydraulic biasing member directly coupled to the inner arm and adapted to pivot the inner arm; and
an actuator coupled to the outer arm, the actuator configured to pivot the inner arm through restraint of the hydraulic biasing member and to cooperatively retract the bunching finger with the hydraulic biasing member.

15. The tree felling head of claim 14 wherein the hydraulic biasing member comprises a cushion configured to reduce the movement rate of the hydraulic biasing member.

16. The bunching finger of claim 14 further comprising a stop positioned to arrest pivotal movement of the inner arm.

17. The tree felling head of claim 14, further comprising a valve connected between the hydraulic circuit and the hydraulic biasing member, the valve configured to alternately allow hydraulic fluid to transfer from the hydraulic motor to the hydraulic biasing member or to allow the hydraulic fluid to transfer from the hydraulic biasing member to a collector.

18. The tree felling head of claim 17 wherein the valve is further configured to allow hydraulic fluid from the hydraulic biasing member to drain to the collector when the hydraulic motor is off.

19. The tree felling head of claim 18 wherein the hydraulic biasing member comprises a rod end and a base end, and wherein the rod end is coupled to the inner arm and the base end is coupled to the frame.

20. The tree felling head of claim 18, wherein the inner arm is pivotally coupled to the frame and configured to pivot toward and away from the accumulation area between a retracted position and a stop position, wherein the outer arm is configured to pivotally sweep the accumulation area from the stop position of the inner arm, and wherein the hydraulic biasing member is configured to urge movement of the bunching finger toward the accumulation area.
